(19) United States
(12) Patent Application Publication
(10) Pub. No.: US 2015/0206158 A1
(43) Pub. Date: Jul. 23, 2015

(54) SYSTEM AND METHOD FOR SPEND ANALYSIS OF THE SERVICE CATEGORY

(71) Applicants: ALOYSIUS GREGORY SEBASTIAN, MUMBAI (IN); PRASAD NAIR, MUMBAI (IN)

(72) Inventors: ALOYSIUS GREGORY SEBASTIAN, MUMBAI (IN); PRASAD NAIR, MUMBAI (IN)

(21) Appl. No.: 14/672,140

(22) Filed: Mar. 28, 2015

Related U.S. Application Data
(63) Continuation-in-part of application No. 13/607,711, filed on Sep. 8, 2012, now abandoned.

(30) Foreign Application Priority Data
Jun. 21, 2012 (IN) 1774/MUM/2012

(51) Int. Cl. G06Q 30/02

(52) U.S. Cl. CPC G06Q 30/0204

(57) ABSTRACT

A computer based system containing service cost model for spend analysis of a spend category, that facilitates analysis of the service procurement cost with respect to market dynamics of labor rates for the underlying services. The system may determine market trends of individual cost components, e.g., primary, secondary and tertiary cost components for a service spend category based on the service cost model of the spend analyzer module. The system may include a processor unit and a computer readable medium storing instructions executable by the processor unit, the computer readable medium including a service receiving system, matching system, associating system, information receiving system, and outputting system.

### CROSS-REFERENCE TO RELATED APPLICATION

The instant application is a continuation-in-part of U.S. patent application Ser. No. 13/607,711, filed Sep. 8, 2012, pending, and claims priority to Indian Patent Application Ser. No. 1774/MUM/2012, filed Jun. 21, 2012, the entire specifications of both of which are expressly incorporated herein by reference.

### FIELD OF THE INVENTION

The present invention relates generally to the field of information and computation systems in relation to service category spend. More particularly, the present invention relates to procurement systems and methods for facilitating the spend analysis of service categories.

### BACKGROUND OF THE INVENTION

Purchasing professionals in organizations often look for ways to optimize the procurement costs (i.e., “spend”) for service categories. These costs are often tied to labor rates and the producer price index (i.e., “PPI”) of the underlying services. As a result, market dynamics of labor rates and PPI have a significant impact on the spending for service categories in the organization.

Accordingly, there exists a need for new and improved techniques for spend analysis of service categories that facilitate the analysis of the impact of the market dynamics of labor rates and PPI on the service category spend that will enable the purchasing professionals to take actions to optimize spend.

### SUMMARY OF THE INVENTION

In accordance with the general teachings of the present invention, a computer based system including a spend analyzer module is provided.

A service cost model of the spend analyzer module may facilitate a spend analysis of a service category based on labor rates for key service spend categories and analysis of the customer spend data with respect to it. The service cost model may facilitate the tracking of labor rates of relevant services and then may associate their spend category to the respective services. The present invention may determine a market trend for a service spend category based on the service cost model.

An object of the present invention is to provide a system and method of a spend analysis of a service category.

A further object of the present invention is to provide a system and method to determine a market trend of individual cost components, e.g., primary, secondary and tertiary cost components for a service spend category based on the service cost model of the spend analyzer module.

The present invention may provide a computer based system including the service cost model for the spend analysis of the spend category, that facilitates analysis of the service procurement cost with respect to market dynamics of labor rates for the underlying services.

In accordance with one embodiment of the present invention, there is provided a computer based system for a spend analysis of a service category, comprising:

a processor unit;

a computer readable medium storing instructions executable by the processor unit, the computer readable medium comprising:

a service receiving system for receiving a service spend category from an information provider module;

a matching system to match a uniform taxonomy code of the service spend category in the information provider module with the uniform taxonomy code or a custom taxonomy code of the service spend category in a spend analyzer module;

an associating system for associating a weighted service cost model to the service spend category based at least on one of the matching results, wherein a service cost model indicates one or more weighted cost drivers to the service spend category;

an information receiving system for receiving information about labor rates and a producer price index associated with at least a subset of the one or more weighted cost drivers in the service cost model, and associating an average market trend of the information about labor rates and the producer price index of one or more weighted cost contributors in a cost component model with an actual purchase trend of the service spend category for a particular period of time; and

an outputting system for outputting an analysis of the spend associated with the service spend category in relation to the weighted service cost model, based at least in part on the average market trend of the information about labor rates and the producer price index.

The associating system of the present system may include a selecting system for selecting a service cost model from a plurality of pre-configured service cost models, and a formulation receiving system for receiving a formulation of the service cost model via a user input. The outputting system may include a trending analysis system for market trend analysis of the service spend in relation to the service cost model.

In accordance with another embodiment of the present invention, there is provided a computer based system for a spend analysis of a service category, comprising:

a host computer;

a processor unit operably associated with the host computer;

a communication interface selectively operable to access the host computer from a plurality of remote input/output devices so as to manage an analysis of at least one service category or spend category for a business process element;

a computer readable medium storing instructions executable by the processor unit to perform the steps of:

providing a service receiving system for receiving a service spend category from an information provider module;

providing a matching system for matching a United Nations Products and Services Code of the service spend category in the information provider module with the United Nations Products and Services Code or a custom taxonomy code of that service spend category in a spend analyzer module;

wherein a taxonomy code of the service spend category in the information provider module is matched automatically with the taxonomy code of that service spend category in the spend analyzer module, wherein a taxonomy code in the spend analyzer module and the information provider module is the United Nations Products and Services Code;

providing an associating system for associating a service cost model to the service spend category based at least on one of the matching results, the service cost model indicating one or more weighted cost drivers to the service spend category;

wherein the service cost model provides relative significance of cost drivers based on market indices of labor rates and the producer price index, wherein the service cost model tracks top three cost drivers of a service spend category;

providing an indicating system for indicating relative significance of one or more cost drivers to the service spend category;

providing an information receiving system for receiving information about labor rates and a producer price index associated with at least a subset of the one or more weighted cost drivers in the service cost model and associating an average market trend of the information about labor rates and the producer price index of one or more weighted cost contributors in a cost component model with an actual purchase trend of that service spend category for a particular period of time;

providing an outputting system for outputting an analysis of spend associated with the service spend category in relation to a weighted service cost model, based at least in part on the average market trend of the information about labor rates and the producer price index; and

providing a trending analysis system for market trend analysis of the service spend in relation to the service cost model.

In accordance with still another embodiment of the present invention, there is provided a method for a spend analysis of a service category, comprising the steps of:

providing a host computer;

providing a processor unit operably associated with the host computer;

providing a communication interface selectively operable to access the host computer from a plurality of remote input/output devices so as to manage an analysis of at least one service category or spend category for a business process element;

providing a computer readable medium storing instructions executable by the processor unit to perform the steps of:

receiving a service spend category from an information provider module;

matching of the United Nations Products and Services Code of the service spend category in the information provider module with the United Nations Products and Services Code or a custom taxonomy code of that service spend category in a spend analyzer module;

wherein a taxonomy code of the service spend category in the information provider module is matched automatically with the taxonomy code of that service spend category in the spend analyzer module, wherein a taxonomy code in the spend analyzer module and the information provider module is the United Nations Products and Services Code;

associating a service cost model to the service spend category based at least on one of the matching results, the service cost model indicating one or more weighted cost drivers to the service spend category;

wherein the service cost model provides relative significance of cost drivers based on market indices of labor rates and the producer price index, wherein the service cost model tracks top three cost drivers of a service spend category;

indicating relative significance of one or more cost drivers to the service spend category;

receiving information about labor rates and a producer price index associated with at least a subset of one or more weighted cost drivers in the service cost model and associating an average market trend of the information about labor rates and the producer price index of the one or more weighted cost contributors in the cost component model with an actual purchase trend of that service spend category for a particular period of time; and

outputting an analysis of spend associated with the service spend category in relation to the weighted service cost model, based at least in part on the average market trend of the information about labor rates and the producer price index;

wherein the analysis includes a market trend analysis of spend for the service category in relation to the service cost model.

The present system is intended for the comparison of the service spends with costs projected by the service cost model, and generation of an alert when a difference between the service spend and the costs projected by the service cost model crosses or exceeds a pre-determined threshold.

These and other various objects, features, advantages, and benefits of the present invention may be more fully appreciated with reference to the detailed description and accompanying drawings that follow.

### BRIEF DESCRIPTION OF THE DRAWINGS

Embodiments of the present invention are illustrated in the figures of the accompanying drawings. The figures are provided to aid a thorough understanding of the invention and are exemplary rather than limiting. Based on the present teachings, a person of ordinary skill in the art may contemplate various alternatives, variations and modifications to the illustrated embodiments within the scope of the invention disclosed herein.

FIG. 1 illustrates an exemplary computer network environment;

FIG. 2 illustrates an exemplary computer apparatus;

FIG. 3 illustrates an exemplary schematic of a system for spend analysis of a service category;

FIG. 4 illustrates a schematic of a computer based system containing a service cost model;

FIG. 5 illustrates a screen capture of a mapping of a service spend category in a spend analyzer module and information provider module based on taxonomy codes;

FIG. 6 illustrates a graph of a service cost model for a computer hardware maintenance service;

FIG. 7 illustrates an exemplary spend analysis output, according to an illustrative embodiment of the present invention;

FIG. 8 illustrates an exemplary cost driver analysis output, according to an illustrative embodiment of the present invention;

FIG. 9 illustrates an exemplary supplier spend analysis output for the cost component model, according to an illustrative embodiment of the present invention; and

FIG. 10 illustrates an exemplary supplier price analysis output for the cost component model, according to an illustrative embodiment of the present invention.

### DETAILED DESCRIPTION OF THE INVENTION

Embodiments of the present invention are illustrated in the figures of the accompanying drawings. The figures are provided to aid thorough understanding of the invention and are exemplary rather than limiting. Based on the present teachings, a person of ordinary skill in the art may contemplate various alternatives, variations and modifications to the illustrated embodiments within the scope of the invention disclosed herein.

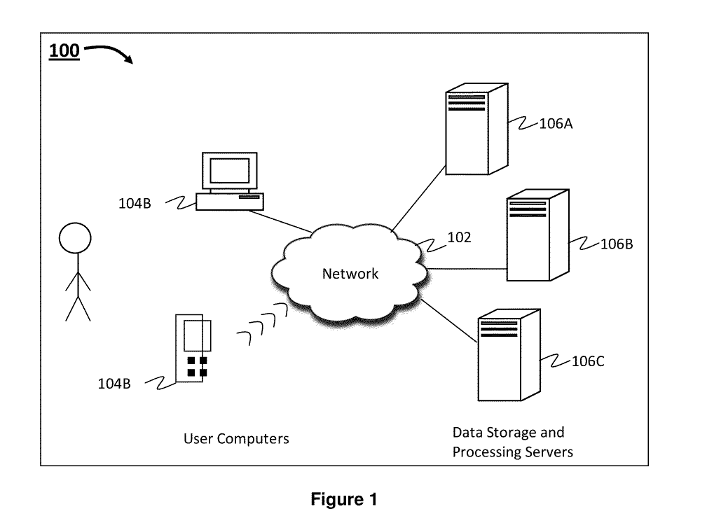

FIG. 1 illustrates an exemplary networked computer system 100 that may provide an environment to practice certain specific embodiments of the present invention. As shown in FIG. 1, multiple end user computer systems 104 and multiple server computer systems 106 may be coupled to a computer network 102. For example, the computer network 102 may be a private network of the organization. In alternative embodiment, the computer network 102 may include the local area network (LAN); and in yet an alternative embodiment it may include the Internet. The end user computer systems 104 may include, without limitation, desktop computers, laptop computers, personal digital assistant (PDAs), and smart phones. The computer systems 104, 106, may exchange information using the computer network 102.

The servers 106 may store digitized content that may be accessed (e.g., read, downloaded, searched, and/or changed, as appropriate) over the computer network. A specific portion of the content may be identified using a hyperlink. The content stored in one server may also be accessed by another server and by the end user computer system. Popular techniques for accessing the content include HTTP (HyperText Transfer Protocol) and HTTPS (HypterText Transfer Protocol Secure), though other techniques may also be used. Access to some portions of the content may require authentication and/or authorization for access.

Depending upon embodiments of the present invention, the servers 106 and the computer systems 104 may be configured to perform certain acts. For example, the servers 106 and the computer systems 104 may include software that may facilitate performing these acts. These acts may include various acts performed by the “spend analysis module,” by the “user interaction module,” for interaction between the “spend analysis module” and the “user interaction module,” for interaction between the “spend analysis module” and the “spend management module.”

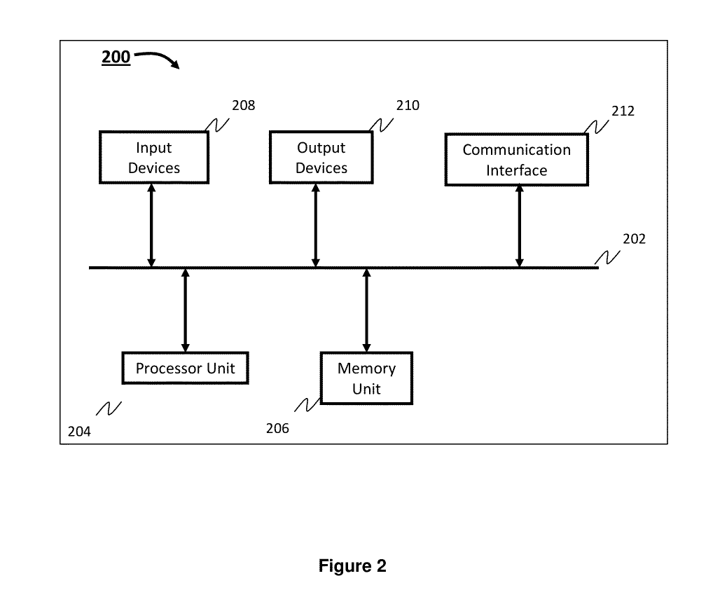

FIG. 2 illustrates an exemplary implementation of any of the servers 106 or any of the end user computer systems 104, according to an embodiment of the present invention. The bus 202 permits communication among the components. The processor unit 204 may include one or more microprocessors, microcontrollers, RISC processors, CISC processors, and/or the like. The processor unit may interpret and execute instructions. The memory unit 206 may include any type of one or more volatile storage devices, for example, random access memory (RAM). The memory unit 206 may, in addition or alternatively, include any type of one or more persistent storage devices, for example read only memory (ROM), read write memory, hard disc, flash memory, and/or the like. The memory unit may store information and instructions for execution by the processor unit 204.

The input devices 208 may include one or more mechanisms that permit an operator to input information, such as a keyboard, mouse, pen, magnetic drives, optical drives, and/or the like. The output devices 210 may include one or more mechanisms that output information to the operator, including a display, a printer, a speaker, and/or the like. The communication interface 212 may include any transceiver mechanism that enables communication with other devices and systems via a network. For example, the communication interface may include Ethernet interface, optical network interface, wireless interface, and/or the like.

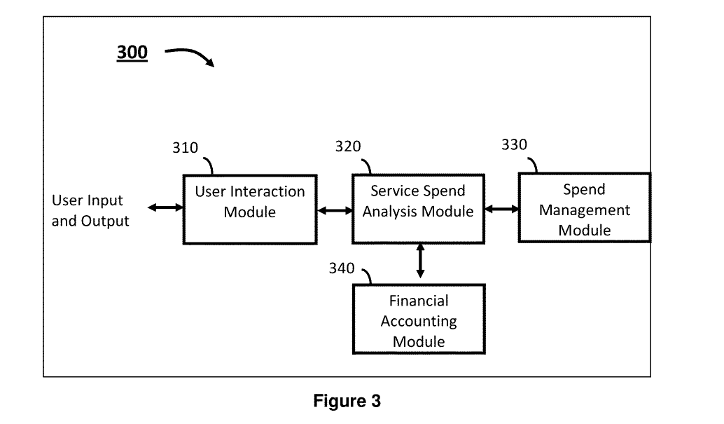

FIG. 3 illustrates an exemplary schematic 300 of a system for spend analysis of service category according to an embodiment of the present invention. As shown in FIG. 3, the system 300 may comprise various modules. Each of these modules may be a hardware module, a software module, or combination thereof. Moreover, depending upon the embodiment, each of the modules may reside on a single computer system or may be distributed across a plurality of interconnected computers. The user interaction module 310 may provide an interface between the user and machine, and perform acts such as receiving an input from the user and providing an output to the user. The spend management module 330 typically stores procurement information, that may identify various spend categories along with their past procurement records and future estimates. The service spend analysis module 320 may perform various acts associated with analyzing the economics of the spend category.

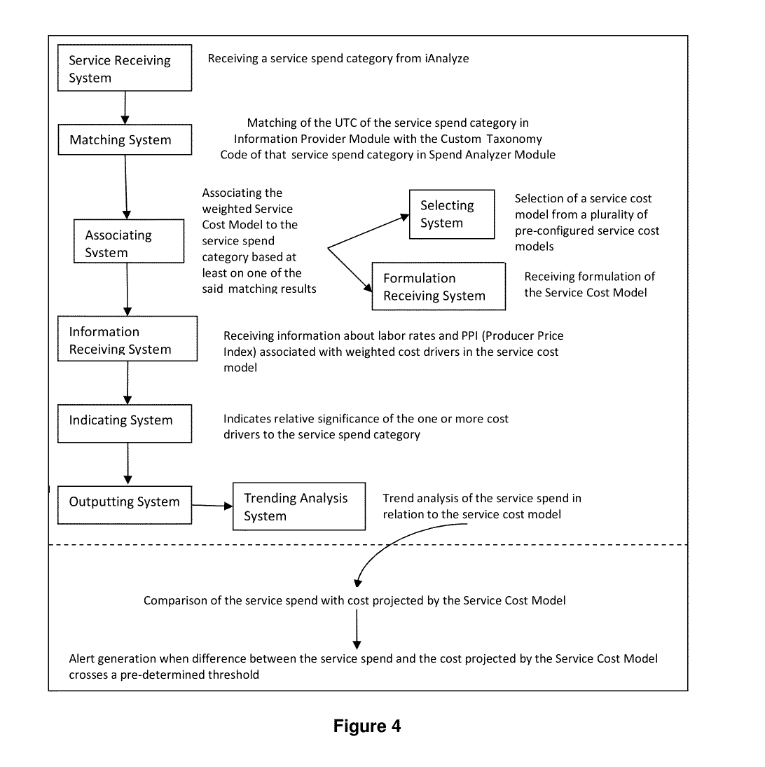

In another specific embodiment of the present invention as shown in FIG. 4, there is provided a computer based system for spend analysis of service category, wherein the system comprises:

a processor unit;

a computer readable medium storing instructions executable by the processor unit, the computer readable medium comprising:

a service receiving system for receiving a service spend category from an information provider module;

a matching system to match a uniform taxonomy code of the service spend category in the information provider module with the uniform taxonomy code or a custom taxonomy code of the service spend category in a spend analyzer module;

an associating system for associating a weighted service cost model to the service spend category based at least on one of the matching results, wherein a service cost model indicates one or more weighted cost drivers to the service spend category;

an information receiving system for receiving information about labor rates and a producer price index associated with at least a subset of the one or more weighted cost drivers in the service cost model, and associating an average market trend of the information about labor rates and the producer price index of one or more weighted cost contributors in a cost component model with an actual purchase trend of the service spend category for a particular period of time; and

an outputting system for outputting an analysis of the spend associated with the service spend category in relation to the weighted service cost model, based at least in part on the average market trend of the information about labor rates and the producer price index.

Typically, matching of the uniform taxonomy code (“UTC”) of the service spend category in the information provider module with the custom taxonomy code of that service spend category in the spend analyzer module is based at least upon the one or more pre-configured matching control rules.

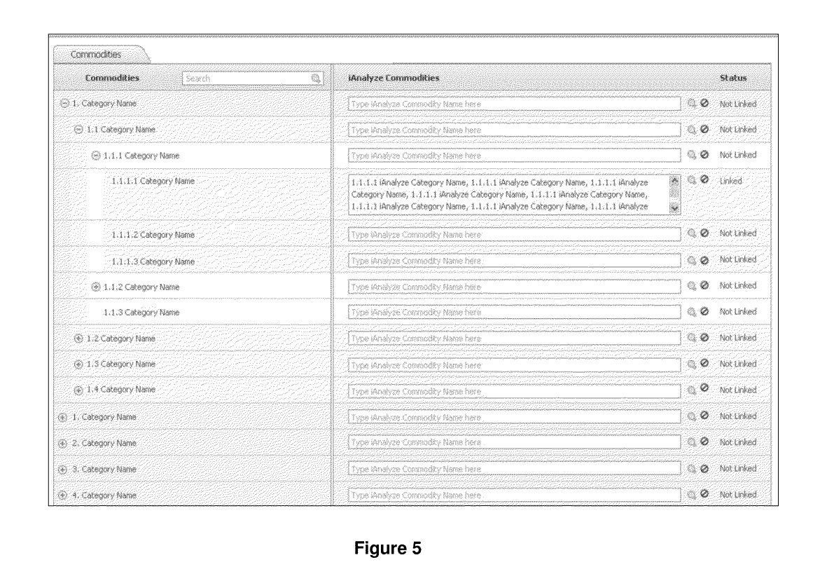

When the taxonomy codes for the service spend category in the spend analyzer module and the information provider module are UNSPC taxonomy codes, taxonomy codes of the service spend category in the information provider module are matched automatically with the custom taxonomy codes of that service spend category in the spend analyzer module (e.g., see FIG. 5).

When the taxonomy codes of the service spend category in the spend analyzer module and the information provider module are different, matching of a UTC of the service spend category in the information provider module with the custom taxonomy code of that service spend category in the spend analyzer module is based on mapping of the service spend category tree. In this case, each node of the service spend category tree in the spend analyzer may be mapped to one or more nodes of the information provider module commodity tree (e.g., see FIG. 5).

Typically, the service cost model further includes an indicating system that indicates the relative significance of the one or more cost drivers to the service spend category.

Typically, the associating system includes a selecting system for selecting a service cost model from a plurality of pre-configured service cost models.

Typically, the associating system includes a selecting system for selecting a service cost model from a plurality of pre-configured service cost models, the selection being responsive to a user input.

Typically, the associating system includes a formulation receiving system for receiving a formulation of the service cost model via a user input.

Typically, the outputting system includes a trending analysis system for a market trend analysis of the service spend in relation to the service cost model.

Typically, the computer readable medium storing further instructions executable by the processor unit performs the steps of:

comparing the service spend with a cost projected by the service cost model; and

generating an alert when a difference between the service spend and the cost projected by the service cost model crosses a pre-determined threshold.

In the system of present invention, the service cost model for a service spend category provides relative significance of cost drivers based on market indices of labor rates and Producer Price Index (“PPI”). This service cost model further tracks the top three cost drivers of a spend category

In still another embodiment of the present invention, pre-configured service cost models are provided. The user is allowed to select the service cost model from these that is appropriate for the service spend category of interest. In this embodiment, the user may also modify the selected pre-configured cost model to better suit the service spend category. In an alternative embodiment, the user may formulate the service cost model for the service spend category by way of selecting individual cost contributors and assigning weightages to them.

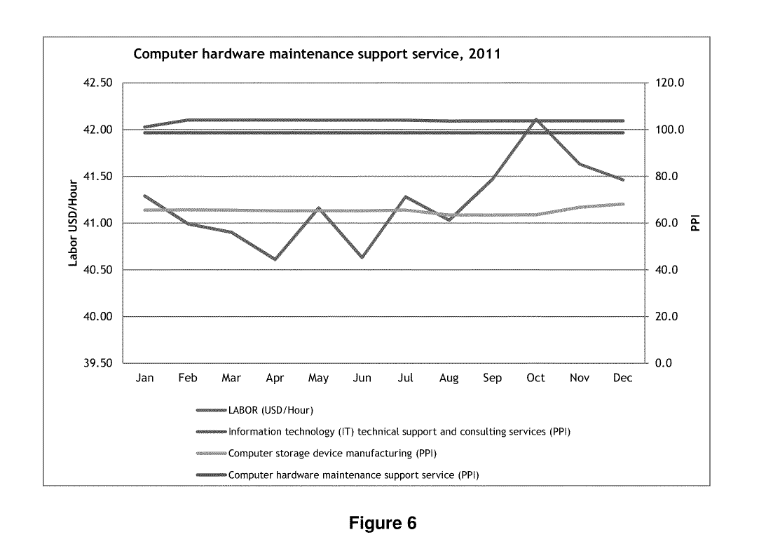

Let's take an example of the service cost model for computer hardware maintenance support services. It suggests that top three cost drivers are labor, storage, personal computer upgrades, and their significance would be 56%, 37% and 5%, respectively. The trend for computer hardware maintenance support services based on primary cost drivers along with PPI is shown in FIG. 6.

The service cost model of present invention is meant to show the market trend for the cost drivers for the service spend category that is for both direct and indirect service spend categories.

The system of present invention provides flexibility to user such that allowing the user to tweak/modify the already available cost models and also further allowing the user to create new cost models.

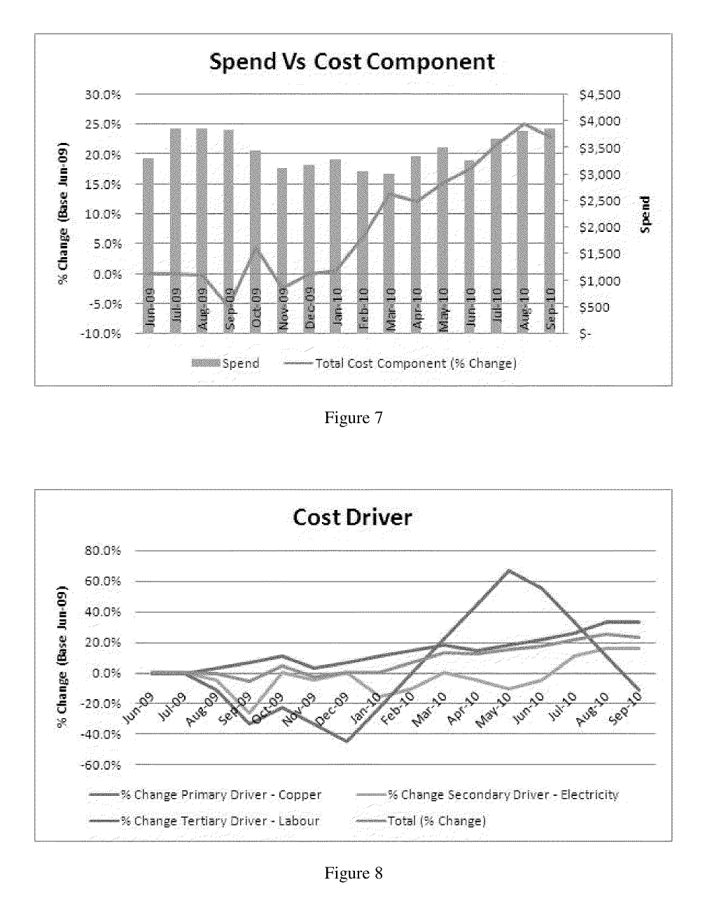

FIG. 7 illustrates a trending analysis comparing the spend with the cost component model, over a period of time. The spend may be actual spend on the spend category performed in the past, or it may be projected future spend, depending upon the embodiment. This exemplary illustration shows how the analysis output may be valuable to purchasing professionals. Based on this example, the purchasing professional may tell that the spend was higher than it should have been in year 2009. This could be an indication of overcharging by the supplier, supplier inefficiency and so forth.

In one embodiment, the present invention is operable to compare the cost component model trend with the spending trend. The difference between the cost component model trend and the spending trend may be computed and compared with a pre-determined threshold. When this difference crosses the pre-determined threshold, an alert may be generated. Such an alert facilitates the purchasing professional to initiate actions such as, but not limited to: re-negotiate with the supplier or change the supplier if the cost component model indicates that the spending trend is higher; and/or re-budget for the procurement if the cost component model indicates that the spending trend is below the cost component model and so forth. In an embodiment of the present invention that utilizes a computer apparatus, the comparison may be performed substantially automatically and substantially regularly. In this embodiment, the alert may be communicated to the user via e-mail, displayed on a computer screen and so on.

By way of a non-limiting example, a demonstration of the practical usefulness of the present invention will now be described below.

With respect to the features of the present invention, they may be divided into the following sub-sections: (1) market indices; (2) cost models; (3) the “my spend” feature; and (4) the dashboard feature.

With respect to the market indices, the present invention may be operable to track the major indices available. These indices could be for commodities, energy, labor, production prices and/or other data. Users would have the option to set them as “favorites” and view their respective trends.

With respect to cost models, the present invention may be operable to provide a cost component model repository for one or more key spend categories. These categories may have a UNSPSC code. Creation of a cost component model could be based on various factors, including, but not limited to, statistical models, dialogues with suppliers and/or collaborations with industry experts. A cost component model for a category could provide relative significance of the cost drivers based on market indices. For example, multiple cost drivers could drive the price of category. By way of a non-limiting example, the present invention may be operable to track the top three cost drivers. For example, consider the above-mentioned category such as ball bearings. The cost component model for ball bearings could suggest that top three cost drivers are stainless steel, labor and electricity and their significance would be 40%, 16% and 10%, respectively. Because the trend for cost drivers may be available from market indices, the trend for each category could be derived based on the cost component model. This is the market trend for the spend category. The present invention could provide cost component models for both direct and indirect categories. The present invention could also be flexible and allow the users to modify already available cost models and/or to create new ones.

With respect to providing the spend data, a system for analyzing spend/service spend category may be provided, wherein there is an interconnection of at least one configurable and namable business process element, wherein the system comprises:

a host computer system;

at least one database component associated with the host computer system; and

a communication interface for accessing the host computer system from a plurality of remote input/output devices to manage an analysis of service category/spend category for the business process element.

For example, the user could provide the service name/spend on the handheld mobile device (e.g., cellular phone, smartphone, PDA, laptop computer, tablet computer, and/or any other like device that is selectively operable to communicate with the host computer system (or component thereof) through a wired and/or wireless connection) for which analysis needs to be done for, e.g., in this example, ball bearings, or computer maintenance. Once the user inserts the input, the input provided on the handheld device may then be matched with the database of the spend category for that input. The mapped category for that item may then be converted into the cost component model by system mapping the category with the configured cost component model. The cost component model may be further made user configured. The user configured cost component model may be further validated by the system which is as follows: the cost component model includes the means to validate the user configured cost component model. That is, to validate whether the major cost contributors have been taken or not, or any major cost contributor has been left out. The cost component so configured by the user may be validated with the existing industry standard databases of cost component models from the real world. A pattern mapping may be done of the major cost component models with the real world model. The deviations, if any, may be provided on handheld devices for approval or rejection by a project manager. The approved cost component model may be taken forward for analysis.

In the present invention, the selection of pricing trend is more complex than conventional methods. In the present invention, the market trend module suggests a market trend based on different geographical regions. For example, a user in United States may also know the market trend for that cost contributor in the United Kingdom, such that the present invention has a robust database to provide comparative market trends for different regions across the globe. With respect to system intelligence, the market trend suggested by the cost contributors may also be mapped against the database of the last 12 month trend for that cost contributor. The present invention also provides a database of the last 12 month trend for that cost contributor to suggest the user as to in which month, generally, the trend of that cost contributor rises up and in which month the trend of that cost contributors subsides. This provides the user with system suggestions to decide in which month the user should buy the component or how many months the user ideally should wait to buy the component.

Cost drivers may have weightage not only based on the cost, but also based on other significant factors like whether the cost driver is a monopolistic item, and still other factors like the importance of its presence in the commodity space. In the present invention, the cost component model may include the means to validate the cost component model. That is, to validate whether the major cost contributor has been taken or not, or if any major cost contributor has been left out. The cost component so configured by the user may be validated with the existing databases of cost component models from the real world. A pattern mapping may be done of the major cost component models with the real world model. The deviations, if any, may be approved or rejected by the project manager. The approved cost component model may then be taken forward for analysis.

With respect to matching a customer spend category with a cost component model, the present invention provides converting the user input into a user configurable cost component model. For example, the customer's spend category may be matched with those categories for which the cost component model exists. For example, the category for which the cost component model has been built may have UNSPSC codes and the customer's uploaded spend categories may also have UNSPSC codes. The matching would be based on the UNSPSC codes and, once it is matched, the cost component model for the category would be associated with the customer's spend category. The tool may be flexible to provide for automatic matching (e.g., based on UNSPSC code, as discussed above) and manual matching. For manual matching, the user may be able to search text which would be contained in category names. The cost component model may be further made user configured. The user configured cost component model may be further validated by a system as follows: in the present invention, the cost component model includes a means to validate the user configured cost component model. That is, to validate whether the major cost contributors have been taken or not or any major cost contributor has been left out. The cost component so configured by the user may be validated with the existing industry standard databases of cost component models from the real world. A pattern mapping may be done of the major cost component models with the real world model. The deviations, if any, may be provided on the handheld device for approval or rejection by the project manager. The approved cost component model may be taken forward for analysis.

With respect to analyzing the customer spend information with respect to the market, the cost component model may consist of cost drivers. The cost drivers may be further converted into value added cost drivers. The cost drivers may be converted into value added cost drivers by associating cost drivers by providing weightage that is not only based on the cost, but also based on other significant factors like whether the cost driver is a monopolistic item, and still other factors like importance of its presence in the commodity space. The value added cost drivers of the cost component model may be further converted into market trend cost drivers by associating market trends with the cost drivers. The present invention may bring market and internal perspectives for analysis purposes. Market information may come from the cost component model based on market indices. Internal information would come from analysis based on customer data. For those customer's spend categories for which the cost component model has been matched detailed analysis may be available.

In the present invention, the selection of pricing trend is more complex than conventional methods. The present invention provides a market trend module that suggests market trend based on different geographical regions, wherein the user can decide between different modules of market trends based on region. For example, a user in the United States may also know the market trend for that cost contributor in the United Kingdom, wherein the present invention has a robust database to provide comparative market trends for different regions across the globe. With respect to system intelligence, the market trend suggested by the cost contributors may also be mapped against the database of the last 12 month trend for that cost contributor. The present invention also provides a database of the last 12 month trend for that cost contributor to suggest to the user as in which month, generally, the trend of that cost contributor rises up and in which month the trend of that cost contributors subsides. The present invention also provides a comparative analysis of the market trend of different regions, wherein the system is also integrated with the supplier database to tie up suggested suppliers for that item in the regions where the item market trend is low. For example, for copper and steel, the user may decide between different modules of market trends based on region, wherein the system may provide region-wise analysis of copper and steel market trends. So, for example, the system may show that the market trend of copper in California is higher compared to the market trend of steel in California, and is low compared to New Jersey. Therefore, it may suggest buying copper from New Jersey, whereas it may suggest buying steel from California. Further, the system may be tied up to the supplier database, and accordingly, based on mapping of an identification of an item with region and with supplier, the system may suggest suppliers for that region for that item. Further, the system may be integrated with the database of supplier performance to fetch reports of supplier performance, its ratings, and for that item show the trend of cost at which the supplier had provided that item in past. Based on the supplier performance report, the system may provide a supplier satisfaction index. Thus, the cost components may be tied up with the market index and supplier satisfaction index for the named suppliers suggested by the system. This provides the user with system suggestions to decide from which region, and from which supplier in which month the user should buy the component or how many months the user ideally should wait to buy the component.

Referring to FIG. 8, a cumulative trend of cost drivers is shown. The analysis shows the trend of individual cost components, e.g., primary, secondary and tertiary. The effect of these cost components on the cumulative (or total) could be highlighted. Referring to the chart, several bits of information can be provided: (1) how is the market behaving?; and (2) do the trend lines show percentage change? To have a comparison based on a common effect (i.e., apples to apples comparison), the 1^{st} month would be taken as a base and all changes with respect to it would be plotted. The same logic of plotting percentage change would be applicable for unit prices also.

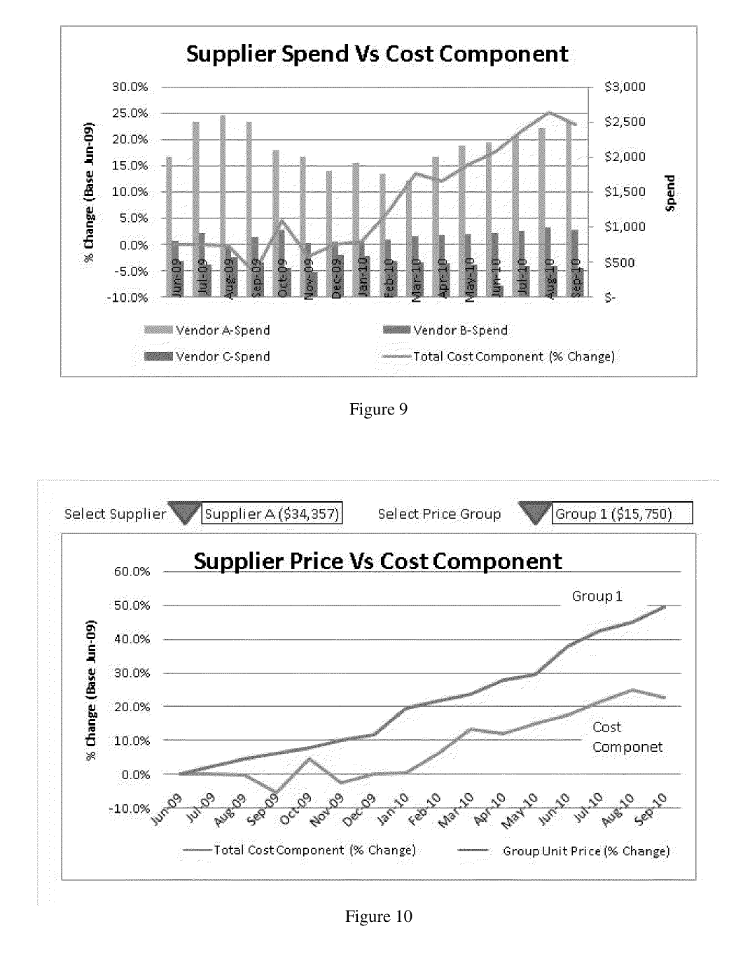

Referring to FIG. 9, a category-wise top three supplier trend and cumulative cost driver trend are shown. That is, the analysis shows the spend for a category for the top three suppliers. This could highlight the significance of various suppliers. Referring to the chart, several bits of information can be provided: (1) who are the top vendors for this category?; and (2) before jumping into a unit price investigation, the user can look at the top suppliers for this category as per the spend so as to be able to analyze the unit prices for only these vendors.

With respect to supplier-wise price trend against cumulative cost driver trend, the analysis could show a comparison of market trends against internal price trends. Market trends could be represented by cumulative cost driver trends. Internal price trends could be represented by supplier-wise unit price trends. Unit prices for the same items within a given category may be found out in order to compare item prices across time. To arrive at supplier-wise unit prices for the same items, data extracted from an analysis may be processed. The following technique could be applied on the transactions level information: (1) select one spend category; (2) select the top three suppliers (by the spend) for this category; (3) for one supplier and one time period, similar line items could be clustered together based on a clustering technique (i.e., transaction clustering); (4) identify unique price identification among clustered data; (5) form groups of unit price (e.g., unit price groups that are close to each other (e.g., tolerance of +/−5 to 10%)); (6) take a simple average unit price for each group; (7) repeat the process for other time periods; (8) match the unit price group across time period (e.g., same line item description across time periods could be matched); (9) sort groups based on the spend; (10) name the groups; (11) transaction within group unit price (i.e., user could have the ability to view transactions that form this group. In addition, they would have the ability to remove transactions from this group in order to improve the data quality); (12) repeat process for other suppliers; (13) plot supplier-wise unit price trend (across time) and compare with market trend.

Referring to FIG. 10, what/how would this look? With respect to an option to select the supplier, the default selection would be the highest spend supplier. Other options would be to pick the second highest supplier and third highest spend supplier. With respect to an option to select the price group, the default selection would be the highest spend unit price group. Other unit price groups would be available in descending order. For example, the selection option would show the spend value in bracket, along with an option to multi-select the price groups.

The main objective of the analysis shown in FIG. 10 is to compare the market trend with the unit price trend. For the selected supplier and respective price group (or groups), the user wants to know how the unit price is behaving vis-a-vis the market. The market trend may be represented by the total cost component that has been derived earlier. The unit price trend may be represented by the average price of the unit price group. This is, the unit price at which the selected supplier is providing the product belonging to the selected category. Accordingly, one should be able to view more than one price group of the same supplier. Therefore, buyers may be provided with leverage opportunities whenever the internal unit price is not in sync with the external market trend. This would provide better negotiating power to the buyer. There could be the following trend analysis: (1) market has gone down, unit price has gone up (i.e., supplier has charged higher price, e.g., see time between August 10 and September 10); (2) market has remained same, unit price has gone up (i.e., see that supplier has charged higher price, e.g., see time between December 9 and January 10); (3) market has gone up, unit price has gone up by higher rate (i.e., supplier has charged higher price, e.g., see time between May 10 and June 10). The above scenarios are in decreasing order of leverage opportunity. It should be noted that there would be other reasons for price changes. The graph shown in FIG. 10 is meant to highlight the trend differences and enable the buyers to make informed decisions. Here, the ability to view the transactions would be useful, as discussed below.

With respect to quantifying the leverage opportunity for the buyer, buyers may be provided with leverage opportunities whenever the internal unit price is not in sync with the external market trend. This could provide better negotiating power to the buyer. There may be an opportunity to save anytime changes in unit price are more than changes in market trend. Quantifying this opportunity could consider change and the spend value. The main objective is to quantify opportunity which exists from automatically analyzing trend. There is an opportunity to save anytime change in unit price is more than change in market trend. How to quantify the opportunity? There may be two variables in calculating the opportunity, i.e., change itself (C) and the spend (S). With respect to change, the higher the differential between unit price change and market change, the higher is this factor. If one takes absolute value of difference in change % for its measure, see the following examples: (1) between August 10 and September 10, the market went down by 5% (−5%) and the unit price went up 7%, then C=Absolute 7-(−5)=12; (2) between December 9 and January 10, the market was the same, i.e., 0%, and the unit price went up 5%, then C=Absolute (5−0)=; (3) between May 10 and June 10, the market was the same, i.e., 2%, and the unit price went up 8%, then C=Absolute (8−2)=6. It should be noted that if the unit price has moved in favor for the buyer, one may exclude this from the opportunity. The assumption here is that the buyer already took advantage of the market.

With respect to the spend, the higher the spend for the selected price group, the higher is this factor. For calculations sake, it is important to normalize this factor. If one wants to give equal weightage to C and S, then the spend would be normalized so that the opportunity is quantified in a meaningful manner. How to make use of this opportunity measure? For the same category and a given time period, opportunity is quantified for all suppliers (or top three) and for all price groups. It could be presented in a tabular format to see how different vendors have performed. In this manner, one could move business to a better scoring supplier.

With respect to the dashboard, it could provide actionable information related to the previously described analysis. It could provide alerts, reminders and notifications for desired commodity and spend categories.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that may store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical smayner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A computer based system for a spend analysis of a service category, comprising:
a host computer;
a processor unit operably associated with the host computer;
a communication interface selectively operable to access the host computer from a plurality of remote input/output devices so as to manage an analysis of at least one service category or spend category for a business process element;
a computer readable medium storing instructions executable by the processor unit to perform the steps of:
providing a service receiving system for receiving a service spend category from an information provider module;
providing a matching system for matching a United Nations Products and Services Code of the service spend category in the information provider module with the United Nations Products and Services Code or a custom taxonomy code of that service spend category in a spend analyzer module;
wherein a taxonomy code of the service spend category in the information provider module is matched automatically with the taxonomy code of that service spend category in the spend analyzer module, wherein a taxonomy code in the spend analyzer module and the information provider module is the United Nations Products and Services Code;
providing an associating system for associating a service cost model to the service spend category based at least on one of the matching results, the service cost model indicating one or more weighted cost drivers to the service spend category;
wherein the service cost model provides relative significance of cost drivers based on market indices of labor rates and the producer price index, wherein the service cost model tracks top three cost drivers of a service spend category;
providing an indicating system for indicating relative significance of one or more cost drivers to the service spend category;
providing an information receiving system for receiving information about labor rates and a producer price index associated with at least a subset of the one or more weighted cost drivers in the service cost model and associating an average market trend of the information about labor rates and the producer price index of one or more weighted cost contributors in a cost component model with an actual purchase trend of that service spend category for a particular period of time;
providing an outputting system for outputting an analysis of spend associated with the service spend category in relation to a weighted service cost model, based at least in part on the average market trend of the information about labor rates and the producer price index; and
providing a trending analysis system for market trend analysis of the service spend in relation to the service cost model.

2. The computer based system for the spend analysis of the service category as claimed in claim 1, wherein the matching of the United Nations Products and Services Code of the service spend category in the information provider module with the custom taxonomy code of that service spend category in the spend analyzer module is based at least upon one or more pre-configured matching control rules.

3. The computer based system for the spend analysis of the service category as claimed in claim 1, wherein matching of the United Nations Products and Services Code of the service spend category in the information provider module is with the custom taxonomy code of that service spend category in the spend analyzer module is based on mapping of a service spend category tree.

4. The computer based system for the spend analysis of the service category as claimed in claim 1, wherein the associating system further comprises a selecting system for selecting a service cost model from a plurality of pre-configured service cost models, the selection being responsive to a user input.

5. The computer based system for the spend analysis of the service category as claimed in claim 1, wherein the associating system further comprises a formulation receiving system for receiving a formulation of the service cost model via a user input.

6. The computer based system for the spend analysis of the service category as claimed in claim 1, wherein the computer readable medium storing further instructions executable by the processor unit to perform the steps of:
comparing the service spend with a cost projected by the service cost model; and
generating an alert when a difference between the service spend and the cost projected by the service cost model crosses a pre-determined threshold.

7. The computer based system for the spend analysis of the service category as claimed in claim 1, wherein the service cost model shows a market trend for the cost drivers for the service spend category.

8. The computer based system for the spend analysis of the service category as claimed in claim 1, wherein the service cost model shows the market trend of cost drivers for both direct and indirect service spend categories.

9. The computer based system for the spend analysis of the service category as claimed in claim 1, wherein the system provides flexibility to a user such that allowing the user to modify already available cost models and also further allowing the user to create a new cost model.

10. A method for a spend analysis of a service category, comprising the steps of:
providing a host computer;
providing a processor unit operably associated with the host computer;
providing a communication interface selectively operable to access the host computer from a plurality of remote input/output devices so as to manage an analysis of at least one service category or spend category for a business process element;
providing a computer readable medium storing instructions executable by the processor unit to perform the steps of:
receiving a service spend category from an information provider module;
matching of the United Nations Products and Services Code of the service spend category in the information provider module with the United Nations Products and Services Code or a custom taxonomy code of that service spend category in a spend analyzer module;
wherein a taxonomy code of the service spend category in the information provider module is matched automatically with the taxonomy code of that service spend category in the spend analyzer module, wherein a taxonomy code in the spend analyzer module and the information provider module is the United Nations Products and Services Code;
associating a service cost model to the service spend category based at least on one of the matching results, the service cost model indicating one or more weighted cost drivers to the service spend category;
wherein the service cost model provides relative significance of cost drivers based on market indices of labor rates and the producer price index, wherein the service cost model tracks top three cost drivers of a service spend category;
indicating relative significance of one or more cost drivers to the service spend category;
receiving information about labor rates and a producer price index associated with at least a subset of one or more weighted cost drivers in the service cost model and associating an average market trend of the information about labor rates and the producer price index of the one or more weighted cost contributors in the cost component model with an actual purchase trend of that service spend category for a particular period of time; and
outputting an analysis of spend associated with the service spend category in relation to the weighted service cost model, based at least in part on the average market trend of the information about labor rates and the producer price index;
wherein the analysis includes a market trend analysis of spend for the service category in relation to the service cost model.

11. The method for the spend analysis of the service category as claimed in claim 10, wherein matching of the United Nations Products and Services Code of the service spend category in the information provider module with the custom taxonomy code of that service spend category in the spend analyzer module is based at least upon one or more pre-configured matching control rules.

12. The method for the spend analysis of the service category as claimed in claim 10, wherein matching of the United Nations Products and Services Code of the service spend category in the information provider module with the custom taxonomy code of that service spend category in the spend analyzer module is based on mapping of a service spend category tree.

13. The method for the spend analysis of the service category as claimed in claim 10, further comprising the step of selecting the service cost model from a plurality of pre-configured service cost models, the selection being responsive to a user input.

14. The method for the spend analysis of the service category as claimed in claim 10, further comprising the step of receiving a formulation of the service cost model via a user input.

15. The method for the spend analysis of the service category as claimed in claim 10, further comprising the steps of:
comparing the service spend with a cost projected by the service cost model; and
generating an alert when a difference between the service spend and the cost projected by the service cost model crosses a pre-determined threshold.

16. The method for the spend analysis of the service category as claimed in claim 10, further comprising the step of showing a market trend for the cost drivers for service spend category.

17. The method for the spend analysis of the service category as claimed in claim 10, further comprising the step of showing a market trend of the cost drivers for both direct and indirect service spend categories.

18. The method for the spend analysis of the service category as claimed in claim 10, further comprising the step of providing flexibility to a user such that allowing the user to modify an already available cost models and also further allowing the user to create a new cost model.
